(19) United States
(12) Patent Application Publication
(10) Pub. No.: US 2006/0254718 A1
(43) Pub. Date: Nov. 16, 2006

(54) Affixing machine

(75) Inventor: Shih-Che Chien, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/378,085

(22) Filed: Mar. 16, 2006

(30) Foreign Application Priority Data
May 10, 2005 (CN) 200510034591.5

(51) Int. Cl. B32B 37/00

(52) U.S. Cl. 156/349

(57) ABSTRACT

An affixing machine (100) for adhering an adhesive tape (30) to a workpiece (20) includes a base (11), a clamp (13), and a pressing element (14). The workpiece is secured in the clamp, and the clamp that is combined with the workpiece is located on the base. The adhesive tape is laid over the clamp. The pressing element is elastomeric and thereby configured for deforming the adhesive tape sufficiently to achieve a substantially contact between the workpiece and the adhesive tape.

### BACKGROUND OF THE INVENTION

1. Field of the Invention

The present invention generally relates to affixing machines for use in dicing process.

2. Discussion of the Related Art

Currently, a dicing saw is used for dicing a wafer or an optical glass. In a dicing process, firstly, the wafer is placed on a flat surface, where a metal frame defining an opening is laid over the wafer with the wafer being within the perimeter of the opening in the metal frame. An adhesive tape is then laid over the metal frame and the wafer. Secondly, force is applied between the adhesive tape and the metal frame to cause the adhesive tape to adhere to the wafer and the metal frame. The wafer is now mounted to the adhesive tape that, in turn, is mounted to the metal frame. Thirdly, the wafer, the adhesive tape, and the metal frame combination is then turned over and placed on a movable chuck in a sawing station. The wafer is diced according to a plan by the dicing saw. It is well appreciated that the adhesive tape provides sufficient suction force to be applied on the chuck and on the wafer to undergo dicing without damaging the wafer or without wafer movement. Lastly, the wafer is exposed by an exposure machine, and the wafer is separated from the adhesive tape, thereby, obtaining a finished product.

One possible technique for applying force between the adhesive tape and the metal frame is to pass a rolling cylinder over the wafer and the metal frame to adhere the adhesive tape to the wafer and to the metal frame. One kind of affixing machine used to adhere an adhesive tape to a wafer is illustrated in FIG. 5. The affixing machine includes a roller 70, a pedestal 71, and a holder 72. The roller 70 is slidably disposed in the pedestal 71, and moves along the pedestal 71. A wafer 73 is clamped in the holder 72. An adhesive tape 74 is laid over the wafer 73. The adhesive tape 74 is adhered to the wafer 73 by rolling the roller 70. However, this can easily lead to air bubbles between the adhesive tape 74 and the wafer 73, because that the adhesive tape 74 is not completely adhered to the wafer 73 by rolling the roller 70. A plurality of wafer chips is scattered when a portion of the wafer 73 adjacent to the air bubbles is diced.

Therefore, what is needed, is an affixing machine for using in the dicing process, whereby an adhesive tape and a workpiece can be adhered completely, thereby, avoiding generating air bubbles.

### SUMMARY OF THE INVENTION

An affixing machine for adhering an adhesive tape to a workpiece includes a base, a clamp, and a pressing element. The clamp is configured for securing a workpiece and is located on the base. The pressing element is elastomeric and thereby configured for deforming the adhesive tape sufficiently to achieve a substantially complete contact between the workpiece and the adhesive tape.

Other advantages and novel features will become more apparent from the following detailed description when taken in conjunction with the accompanying drawings.

### BRIEF DESCRIPTION OF THE DRAWINGS

Many aspects of the affixing machine can be better understood with reference to the following drawings. The components in the drawings are not necessarily to scale, the emphasis instead being placed upon clearly illustrating the principles of the present affixing machine. Moreover, in the drawings, like reference numerals designate corresponding parts throughout the several views.

FIG. 1 is a schematic view of an affixing machine in accordance with a preferred embodiment of the present invention;

FIG. 2 is an operational view of the affixing machine of FIG. 1, showing a small interface between a workpiece and an adhesive tape;

FIG. 3 is similar to FIG. 2, but showing a larger interface between the workpiece and the adhesive tape;

FIG. 4 is similar to FIG. 3, but showing a complete interface between the workpiece and the adhesive tape;

FIG. 5 is a schematic view of a conventional affixing machine.

### DETAILED DESCRIPTION OF THE EMBODIMENTS

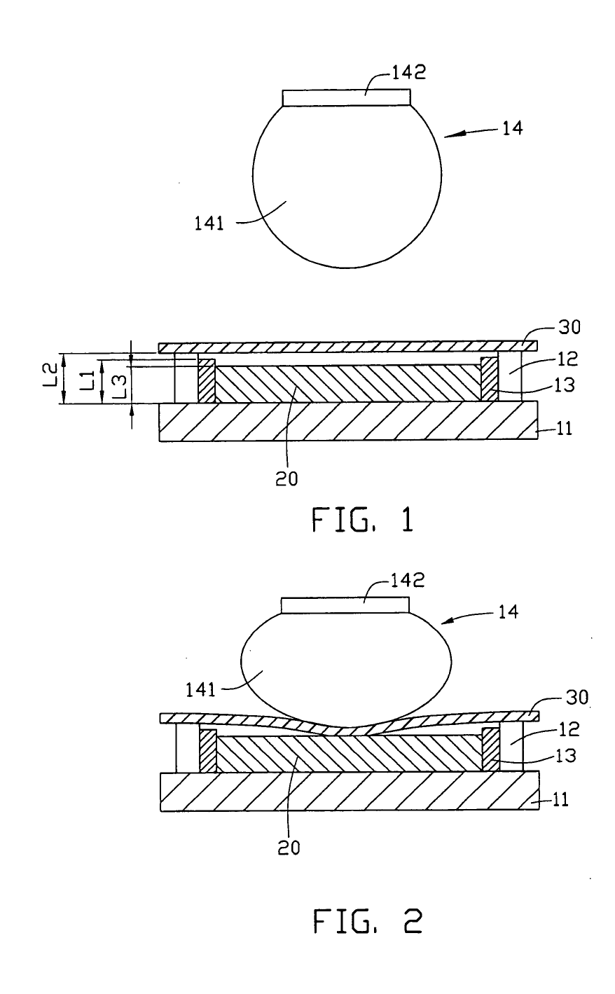

Referring to FIG. 1, an affixing machine 100 according to a preferred embodiment of the present invention includes a base 11, a frame 12, a clamp 13 and an elastic pressing element 14. The affixing machine 100 is used to adhere an adhesive tape 30 to a workpiece 20, such as a wafer or lens.

The frame 12 is used for positioning the adhesive tape 30 in a position separate from the workpiece 20. The frame 12 is a substantially hollow cylinder. The frame 12 can alternatively be of another shape, such as cuboid. The frame 12 is secured to the base 11 by using, for example, a nail or a screw.

The clamp 13 is also a substantially hollow cylinder. The clamp 13 can alternatively be of another shape, such as cuboid. The clamp 13 is disposed in the frame 12. The clamp 13 is used for securing the workpiece 20. In the illustrated embodiment, a height of the clamp 13 is L1, a height of the frame 12 is L2, a height of the workpiece 20 is L3, and L3<L1<L2.

The pressing element 14 is slidably disposed above the base 11. The pressing element 14 is used for pressing the adhesive tape 30 to contact with the workpiece 20. The pressing element 14 includes an elastic member 141 and a board 142. The elastic member 141 is secured with the board 142 by using, for example, a glue/adhesive. The elastic member 141 includes a spherical elastic bag (not labeled) with a flowable medium, for example, liquid/gas, contained therein. Therefore, the elastic member 141 is easily deformable.

In the mount, initially, the frame 12 is secured to the base 11, and a workpiece 20 is secured in the clamp 13. Secondly, the clamp 13 that is combined with the workpiece 20 is located on the base 11, and is simultaneously disposed in the frame 12. Thirdly, the pressing element 14 is disposed above the workpiece 20. Fourthly, an adhesive tape 30 is laid over the frame 12. The adhesive tape 30 may be, but is not limited to, a pressure sensitive silicone adhesive tape, acrylic adhesive tape, ultraviolet (UV) adhesive tape, and/or any adhesive tape that allows the adhesive tape 30 to be easily removed without damaging the workpiece 20. In the illustrated embodiment, the adhesive tape 30 is an UV adhesive tape.

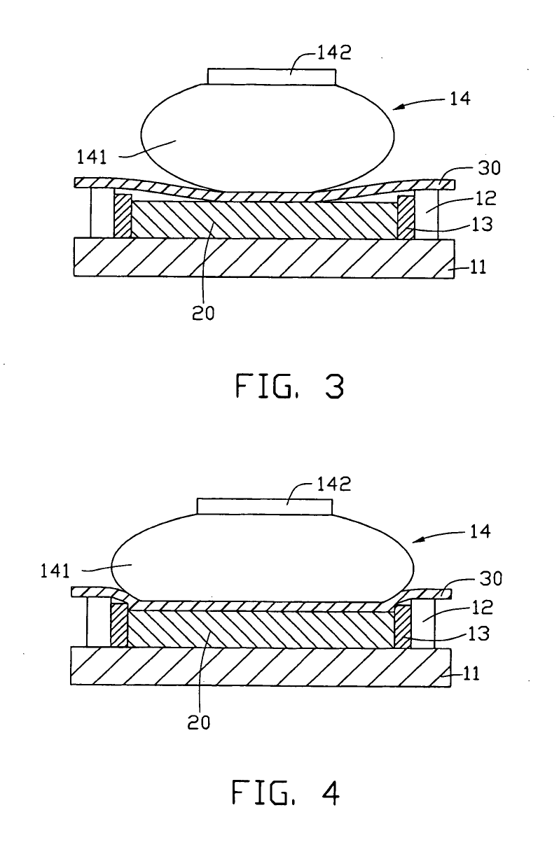

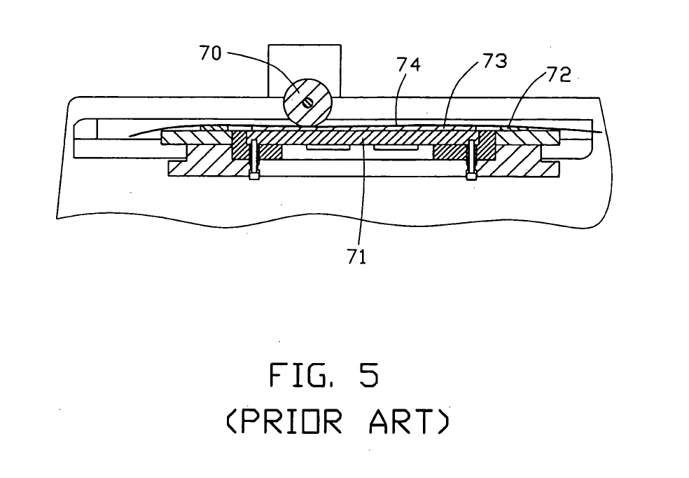

Referring to FIG. 2 to FIG. 4, in operation, the pressing element 14 is moved toward the adhesive tape 30 in a direction perpendicular to the base 11 manually and/or by machinery which acts on the board 142 of the pressing element 14. At first, the elastic member 141 of the pressing element 14 contacts with the adhesive tape 30 to cause the adhesive tape 30 to deform to contact with the workpiece 20. An initial interface between the elastic member 141 of the pressing element 14 and the adhesive tape 30 is small, an initial interface between the adhesive tape 30 and the workpiece 20 is also small and is located at a substantially central portion of the workpiece 20 (as best seen in FIG. 2). As the pressing element 14 continues to move, the elastic member 141 of the pressing element 14 deforms due to a counteraction from the adhesive tape 30 and the workpiece 20, the interface between the elastic member 141 and the adhesive tape 30 becomes larger, and the interface between the adhesive tape 30 and the workpiece 20 also becomes larger and spreads radially from the central portion toward a perimeter of the workpiece 20 (as best seen in FIG. 3). As the pressing element 14 further moves down, the adhesive tape 30 is deformed to achieve a substantially complete contact between the workpiece 20 and the adhesive tape 30 (as best seen in FIG. 4).

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An affixing machine, comprising:
a base;
a clamp located on the base, the clamp being configured for securing a workpiece; and
a pressing element, the pressing element being elastomeric and thereby configured for deforming an adhesive tape sufficiently to achieve substantially complete contact between the workpiece and the adhesive tape.

2. The affixing machine as claimed in claim 1, wherein the affixing machine further comprises a frame, the frame is a substantially hollow cylinder, and is secured to the base.

3. The affixing machine as claimed in claim 2, wherein the clamp is a substantially hollow cylinder, and is disposed in the frame.

4. The affixing machine as claimed in claims 3, wherein a height of the clamp is smaller than that of the frame.

5. The affixing machine as claimed in claims 3, wherein a height of the workpiece is smaller than that of the clamp.

6. The affixing machine as claimed in claim 1, wherein the pressing element comprises an elastic member and a board secured with the elastic member.

7. The affixing machine as claimed in claim 6, wherein the elastic member comprises a spherical elastic bag with a flowable medium contained therein.

8. The affixing machine as claimed in claim 7, wherein the medium is one of a liquid and a gas.

9. A method for adhering an adhesive tape to a workpiece, comprising the steps of:
securing the workpiece on a base;
positioning the adhesive tape in a position separate from the workpiece; and
pressing the adhesive tape by an elastomeric pressing element to deform the adhesive tape sufficiently to achieve substantially complete contact between the workpiece and the adhesive tape.

10. The method as claimed in claim 9, further comprises securing a frame on the base, wherein the frame is a substantially hollow cylinder.

11. The method as claimed in claim 10, wherein the clamp is a substantially hollow cylinder, and is disposed in the frame.

12. The method as claimed in claims 11, wherein a height of the clamp is smaller than that of the frame, and a height of the workpiece is smaller than that of the clamp.

13. The method as claimed in claim 9, wherein the pressing element comprises an elastic member and a board secured with the elastic member.

14. The method as claimed in claim 13, wherein the elastic member comprises a spherical elastic bag with a flowable medium contained therein.

15. The method as claimed in claim 14, wherein the medium is one of a liquid and a gas.

16. The method as claimed in claim 9, wherein during pressing the adhesive tape, an interface between the adhesive tape and the workpiece becomes larger and spreads from a central portion toward a perimeter of the workpiece.

17. A mounting apparatus for mounting a tape onto a workpiece, the mounting apparatus comprising:
a base having a base surface;
a clamp located on the base surface, the clamp being configured for positioning the workpiece on the base;
a pressing element being movable toward the base in a direction perpendicular to the base surface to deform the tape into contact with the workpiece, wherein the pressing element comprises a deformable pressing portion configured for pressing the tape in a manner that an interface between the pressing portion and the tape becomes larger as the pressing element moves toward the base.

18. The mounting apparatus of claim 17, wherein the workpiece is one of a wafer and a lens.
